(19) United States
(12) Patent Application Publication
(10) Pub. No.: US 2025/0296022 A1
(43) Pub. Date: Sep. 25, 2025

(54) FILTER AND FILTER DEVICE

(71) Applicant: Murata Manufacturing Co., Ltd., Nagaokakyo-shi (JP)

(72) Inventors: Tomoka YAMAMOTO, Nagaokakyo-shi (JP); Takashi KONDO, Nagaokakyo-shi (JP)

(21) Appl. No.: 19/227,678

(22) Filed: Jun. 4, 2025

Related U.S. Application Data
(63) Continuation of application No. PCT/JP2024/001154, filed on Jan. 17, 2024.

(30) Foreign Application Priority Data
Mar. 2, 2023 (JP) 2023-031773

(51) Int. Cl. B01D 39/20

(52) U.S. Cl. CPC B01D 39/2027; B01D 2201/04; B01D 2201/184

(57) ABSTRACT

A filter that includes: a filter part having a plurality of through-holes; a frame portion on an outer periphery of the filter part; and a tab that protrudes from an outer periphery of the frame portion, the tab having a plurality of protrusions.

### CROSS REFERENCE TO RELATED APPLICATIONS

The present application is a continuation of International application No. PCT/JP2024/001154, filed Jan. 17, 2024, which claims priority to Japanese Patent Application No. 2023-031773, filed Mar. 2, 2023, the entire contents of each of which are incorporated herein by reference.

### TECHNICAL FIELD

The present disclosure relates to a filter and a filter device.

### BACKGROUND ART

For example, Patent Document 1 discloses a void disposition structure body having a void disposition portion in which a plurality of voids are arranged.

Patent Document 1: International Publication No. 2015/005088

### SUMMARY OF THE DISCLOSURE

In recent years, there has been a demand for a filter that can be easily held.

An object of the present disclosure is to provide a filter that can be easily held and a filter device including the filter.

A filter according to an aspect of the present disclosure includes: a filter part having a plurality of through-holes; a frame portion on an outer periphery of the filter part; and a tab that protrudes from an outer periphery of the frame portion, the tab having a plurality of protrusions.

A filter device according to an aspect of the present disclosure includes: a filter; and a holder that holds the filter, in which the filter includes: a filter part having a plurality of through-holes, a frame portion on an outer periphery of the filter part, and a tab that protrudes from an outer periphery of the frame portion, the tab having a plurality of protrusions, the holder includes: a first holder that has a cylindrical shape, and a second holder that has a cylindrical shape and has an inner flange protruding from an inner wall thereof, the first holder is disposed in the second holder, the tab of the filter is disposed between an end surface of the first holder and the inner flange of the second holder, and the plurality of protrusions of the tab are in contact with at least one of the end surface of the first holder and the inner flange of the second holder.

According to the present disclosure, it is possible to provide a filter that can be easily held and a filter device including the filter.

### BRIEF DESCRIPTION OF THE DRAWINGS

FIG. 1 is a schematic plan view of an example of a filter according to Embodiment 1 of the present disclosure as viewed from a first main surface side.

FIG. 2 is an enlarged perspective view of a part of a filter part.

FIG. 3 is an enlarged plan view of a part of the filter part.

FIG. 4 is an enlarged perspective view of a tab.

FIG. 5 is an enlarged side view of the tab.

FIG. 6 is a schematic perspective view of an example of a filter device according to Embodiment 1 of the present disclosure.

FIG. 7 is a schematic sectional view taken along line A-A of the filter device of FIG. 6.

FIG. 8 is an enlarged sectional view of a part of the filter device.

FIG. 9 is a schematic enlarged sectional view of a part of a filter of Modification Example 1.

FIG. 10 is a schematic enlarged view of a part of a filter of Modification Example 2.

FIG. 11 is a schematic enlarged sectional view of a part of a filter of Modification Example 3.

FIG. 12 is a schematic enlarged sectional view of a part of a filter of Modification Example 4.

FIG. 13 is a schematic plan view of a filter of Modification Example 5.

FIG. 14 is a schematic enlarged view of Z1 portion of the filter of Modification Example 5 of FIG. 13.

FIG. 15A is a schematic view showing an example of a manufacturing process of the filter according to Embodiment 1 of the present disclosure.

FIG. 15B is a schematic view showing an example of a manufacturing process of the filter according to Embodiment 1 of the present disclosure.

FIG. 15C is a schematic view showing an example of a manufacturing process of the filter according to Embodiment 1 of the present disclosure.

FIG. 15D is a schematic view showing an example of a manufacturing process of the filter according to Embodiment 1 of the present disclosure.

FIG. 15E is a schematic view showing an example of a manufacturing process of the filter according to Embodiment 1 of the present disclosure.

FIG. 15F is a schematic view showing an example of a manufacturing process of the filter according to Embodiment 1 of the present disclosure.

FIG. 15G is a schematic view showing an example of a manufacturing process of the filter according to Embodiment 1 of the present disclosure.

FIG. 16 is a schematic view showing an example of a filter sheet.

FIG. 17A is a schematic view showing an example of a manufacturing process of the filter according to Embodiment 1 of the present disclosure.

FIG. 17B is a schematic view showing an example of a manufacturing process of the filter according to Embodiment 1 of the present disclosure.

### DESCRIPTION OF THE PREFERRED EMBODIMENTS

Hereinafter, Embodiment 1 according to the present disclosure will be described with reference to the accompanying drawings. In each drawing, each element is exaggerated for ease of description.

### Embodiment 1

### Filter

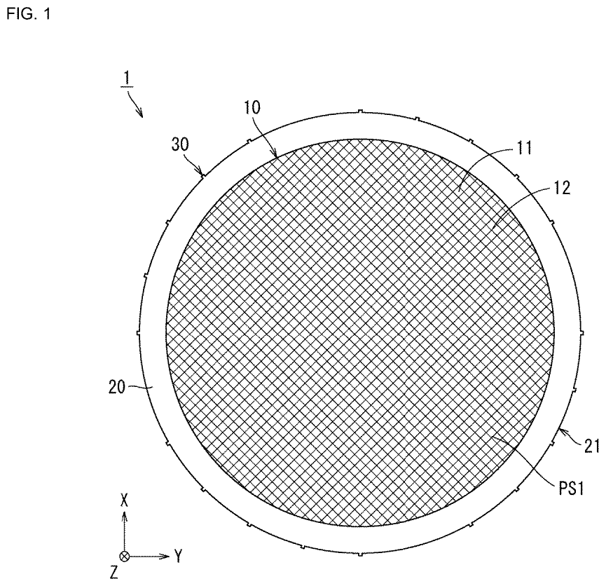

FIG. 1 is a schematic plan view of an example of a filter 1 according to Embodiment 1 of the present disclosure as viewed from a first main surface PS1 side. In the drawings, the X, Y, and Z directions respectively indicate a longitudinal direction, a transverse direction, and a thickness direction of the filter 1.

For example, the filter 1 is a filter that filters a fluid containing a filtration target.

In the present specification, the “filtration target” means a target object to be filtered out among objects contained in a fluid. For example, the filtration target may be a biological material contained in a fluid. The “biological material” means a material derived from a living organism such as a cell (eukaryotic organism), a bacterium (true bacterium), or a virus. Examples of the cells (eukaryotic organisms) include induced pluripotent stem cells (iPS cells), ES cells, stem cells, mesenchymal stem cells, mononuclear cells, single cells, cell aggregates, floating cells, adherent cells, nerve cells, leukocytes, cells for regenerative medicine, autologous cells, cancer cells, circulating tumor cells (CTC), HL-60, HELA, and fungi. Examples of the bacterium (true bacterium) include Gram-positive bacteria, Gram-negative bacteria, Escherichia coli, and Mycobacterium tuberculosis.

Examples of the fluid include a liquid or a gas. Examples of the liquid include an electrolyte solution, a cell suspension, and a cell culture medium.

The filter 1 is a metal filter. The material constituting the filter 1 contains at least any one of a metal and a metal oxide as a main component. With such a configuration, it is possible to further improve usability while improving mechanical strength. The material constituting the filter 1 may be, for example, gold, silver, copper, platinum, nickel, palladium, titanium, an alloy thereof, or an oxide thereof. In particular, when titanium or a nickel-palladium alloy is used, the elution of the metal is small, and the influence on the filtration target can be reduced.

As shown in FIG. 1, the filter 1 includes a filter part 10, a frame portion 20 provided on an outer periphery of the filter part 10, and a tab 30 that protrudes from an outer periphery 21 of the frame portion 20. In Embodiment 1, the filter part 10, the frame portion 20, and the tab 30 are formed integrally.

### Filter Part

The filter part 10 is a portion that filters a fluid containing a filtration target.

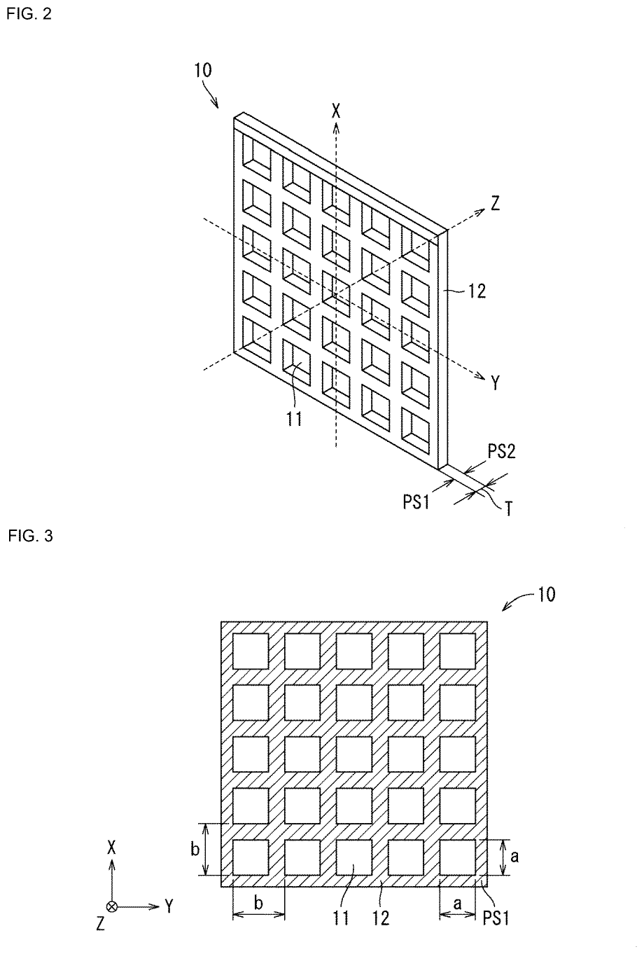

FIG. 2 is an enlarged perspective view of a part of the filter part 10. FIG. 3 is an enlarged plan view of a part of the filter part 10. As shown in FIGS. 2 and 3, the filter part 10 has the first main surface PS1 and a second main surface PS2 opposite to the first main surface PS1. The filter part 10 is composed of a filter substrate part 12 in which a plurality of through-holes 11 are provided. The plurality of through-holes 11 connect the first main surface PS1 and the second main surface PS2.

In Embodiment 1, the filter substrate part 12 is formed in a grid shape. Specifically, the filter substrate part 12 is formed of a plurality of rod-like members extending at equal intervals in the X direction and the Y direction. Accordingly, the plurality of square through-holes 11 are formed in the filter part 10.

The through-hole 11 has a square shape having one side of a length a as viewed from the first main surface PS1 side of the filter part 10, that is, the Z direction. The length a of one side of the through-hole 11 is appropriately designed according to the size, shape, properties, elasticity, or amount of the filtration target.

For example, the length a of one side of the through-hole 11 is 0.01 μm to 500 μm. Preferably, the length a of one side of the through-hole 11 is 1 μm to 200 μm.

The shape of the through-hole 11 is not limited to a square as viewed from the first main surface PS1 side. For example, the shape of the through-hole 11 may be a circular shape, an elliptical shape, a rectangular shape, a polygonal shape, or the like as viewed from the first main surface PS1 side.

The plurality of through-holes 11 are periodically provided. Specifically, the plurality of through-holes 11 are provided in the filter part 10 at equal pitches in a matrix shape.

In Embodiment 1, the plurality of through-holes 11 are provided in two arrangement directions parallel to respective sides of the square as viewed from the first main surface PS1 side (Z direction) of the filter part 10, that is, along the X direction and the Y direction in FIG. 3. As described above, by providing the plurality of through-holes 11 in a square grid arrangement, it is possible to increase the opening ratio, and it is possible to reduce the resistance of the filter 1 to the fluid. With such a configuration, it is possible to shorten the processing time and reduce the stress on the filtration target. In addition, since the symmetry of the arrangement of the plurality of through-holes 11 is improved, the filter 1 is easily observed.

The arrangement of the plurality of through-holes 11 is not limited to the square grid arrangement, and may be, for example, a quasi-periodic arrangement or a periodic arrangement. Examples of the periodic arrangement include a quadrangular arrangement such as a rectangular arrangement, which has different pitches in two arrangement directions, a triangular grid arrangement, and a regular triangular grid arrangement. The through-holes 11 may be provided in any arrangement in the filter part 10, as long as a plurality of through-holes 11 are provided in the filter part 10.

A pitch b of the through-holes 11 is appropriately designed depending on the filtration target to be separated. For example, in a case where the filtration target is a cell, the pitch b of the through-holes 11 is appropriately designed according to the type (size, shape, properties, and elasticity) or the amount of the cell. Here, the pitch b of the square through-holes 11 means a distance between one side of any through-hole 11 and the corresponding side of the adjacent through-hole 11, as viewed from the first main surface PS1 side of the filter part 10.

In the case of the periodic arrangement structure, the pitch b of the through-holes 11 is, for example, more than 1 time and 10 times or less the length a of one side of the through-hole 11, and is preferably 3 times or less the length a of one side of the through-hole 11. Alternatively, for example, the opening ratio of the filter part 10 is 10% or more, and the opening ratio is preferably 25% or more. With such a configuration, it is possible to reduce the resistance of the filter part 10 to the fluid. Therefore, the processing time can be shortened, and the stress on the cells can be reduced. The opening ratio is calculated as (area occupied by the through-holes 11)/(projected area of the first main surface PS1, assuming that the through-holes 11 are not formed)×100.

An opening on the first main surface PS1 side and an opening on the second main surface PS2 side of the through-hole 11 communicate with each other via a continuous wall surface. Specifically, the through-hole 11 is provided such that an opening on the first main surface PS1 side is projectable onto an opening on the second main surface PS2 side. That is, when the filter part 10 is viewed from the second main surface PS2 side, the through-hole 11 is provided such that the opening on the second main surface PS2 side overlaps the opening on the first main surface PS1 side. In Embodiment 1, the inner wall that defines the through-hole 11 is provided to be perpendicular to the first main surface PS1 and the second main surface PS2. With such a configuration, the cell is less likely to come into contact with the inner wall surface of the through-hole 11, and the stress on the cell can be reduced. Furthermore, clogging of the through-hole 11 by cells or the like can be easily detected.

The outer shape of the filter part 10 is, for example, a circle, a polygon, or an ellipse as viewed from the thickness direction (Z direction) of the filter 1. In Embodiment 1, the shape of the filter part 10 is substantially circular. In the present specification, the term “substantially circular” means that a ratio of a length of a major axis to a length of a minor axis is 1.0 to 1.2.

In the filter part 10, it is preferable that the surface roughness of the first main surface PS1 and the second main surface PS2 is small. Here, the surface roughness means an average value of differences between a maximum value and a minimum value measured by using a stylus type step profiler at any five points. In Embodiment 1, the surface roughness is preferably smaller than the size of the filtration target, and more preferably smaller than half the size of the filtration target. This is because the adhesion of the filtration target is reduced, and the filtration target can be efficiently recovered after being captured by the filter 1.

### Frame Portion

Returning to FIG. 1, the frame portion 20 is provided on the outer periphery of the filter part 10, and is a portion in which the number of through-holes 11 per unit area is smaller than that in the filter part 10. The number of through-holes 11 in the frame portion 20 is 25% or less of the number of through-holes 11 in the filter part 10. The thickness of the frame portion 20 may be larger than the thickness of the filter part 10. With such a configuration, the mechanical strength of the filter 1 can be increased, and the inflow of cells into the frame portion 20 can be prevented.

In the frame portion 20, the information on the filter 1 may be displayed by using characters, symbols, or the like. For example, the dimensions of the through-hole 11, the outer diameter dimensions of the filter 1, and the like may be displayed on the frame portion 20.

The frame portion 20 is formed in a ring shape as viewed from the first main surface PS1 side of the filter part 10. When the filter 1 is viewed from the first main surface PS1 side, the center of the frame portion 20 coincides with the center of the filter part 10. That is, the frame portion 20 is formed concentrically with the filter 1.

### Tab

The tab 30 protrudes from the outer periphery 21 of the frame portion 20. The tab 30 is provided to extend from the frame portion 20 in a direction away from the filter part 10, as viewed from the first main surface PS1 side of the filter part 10. The tab 30 is partially provided on the outer periphery 21 of the frame portion 20.

For example, the length of the tab 30 in the protruding direction is 500 μm or less. The length of the tab 30 in the width direction is 0.1 μm to 500 μm. The width direction of the tab 30 is a direction orthogonal to the protruding direction of the tab 30 as viewed from the first main surface PS1 side. The thickness of the tab 30 is the same as the thickness of the frame portion 20. With such a configuration, the mechanical strength of the filter 1 can be increased.

In Embodiment 1, the tab 30 includes a plurality of tabs 30. The plurality of tabs 30 are provided at equal intervals on the outer periphery 21 of the frame portion 20. The number of the plurality of tabs 30 is not limited as long as there are at least 2 or more tabs 30. Preferably, the number of the plurality of tabs 30 is 4 to 400. The disposition and the number of tabs 30 are not limited. For example, the dimensions of the through-holes 11 can be identified by changing the disposition and the number of tabs 30 for each dimension of the through-holes.

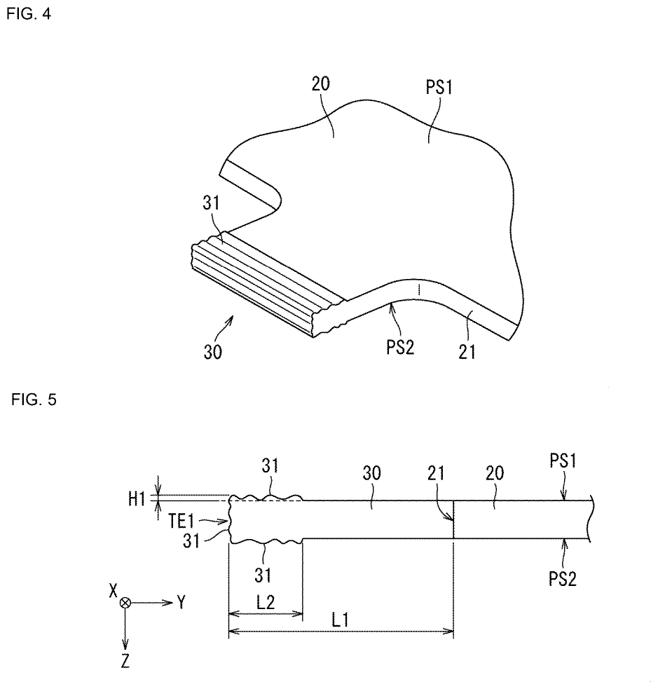

FIG. 4 is an enlarged perspective view of the tab 30. FIG. 5 is an enlarged side view of the tab 30. As shown in FIGS. 4 and 5, the tab 30 has a plate shape. For example, the tab 30 has a substantially rectangular shape as viewed from the first main surface PS1 side. For example, the corners of the tab 30 may be rounded. With such a configuration, it is possible to reduce the load in a case where the cells come into contact with the corners of the tab 30.

A plurality of protrusions 31 are provided on the tab 30. The plurality of protrusions 31 are provided on the surface near an end portion of the tab 30. In Embodiment 1, the plurality of protrusions 31 are provided on the first main surface PS1, the second main surface PS2, and an end surface TE1 of the tab 30. The end surface TE1 is a surface provided at the tip of the tab 30. The plurality of protrusions 31 protrude in the thickness direction of the tab 30 on the first main surface PS1 and the second main surface PS2 and protrude in the protruding direction of the tab 30 on the end surface TE1. The plurality of protrusions 31 are formed to extend from a side surface of the tab 30 toward the other side surface of the tab 30. The side surface and the other side surface of the tab 30 are surfaces that connect the first main surface PS1 and the second main surface PS2 in the thickness direction of the tab 30 and are connected to each other via the end surface TE1 of the tab 30. The side surface and the other side surface of the tab 30 are disposed to face each other.

A height H1 of the plurality of protrusions 31 is smaller than the size of the openings of the plurality of through-holes 11. Specifically, the height H1 of the plurality of protrusions 31 is smaller than the maximum width of the openings of the plurality of through-holes 11 when the openings are viewed from the first main surface PS1. For example, in a case where the shape of the through-hole 11 is a circle, the maximum width of the opening is a diameter. In a case where the shape of the through-hole 11 is an ellipse, the maximum width of the opening is the length of the major axis. In a case where the shape of the through-hole 11 is rectangular, the maximum width of the opening is the length of the side in the longitudinal direction. In Embodiment 1, since the through-hole 11 has a square shape, the height H1 of the plurality of protrusions 31 is smaller than the length a of one side of the plurality of through-holes 11.

The plurality of protrusions 31 are arranged in a predetermined direction. In Embodiment 1, the plurality of protrusions 31 are arranged in the protruding direction of the tab 30. That is, the arrangement direction of the plurality of protrusions 31 is the protruding direction of the tab 30.

The plurality of protrusions 31 are provided within a predetermined distance L2 from the end surface TE1 of the tab 30. The predetermined distance L2 is 1/20 to ¾ of a length L1 of the tab 30 in the protruding direction. Preferably, the predetermined distance L2 is 1/10 to ⅔ of the length L1 of the tab 30 in the protruding direction.

The plurality of protrusions 31 have a projecting shape. For example, the plurality of protrusions 31 have a substantially semicircular shape. Alternatively, the plurality of protrusions 31 may have a substantially trapezoidal shape.

In this way, by providing the plurality of protrusions 31 on the tab 30, the tab 30 is formed with a wave-like unevenness.

The plurality of protrusions 31 are not limited to being formed to extend from the side surface to the other side surface of the tab 30, and the direction in which the plurality of protrusions 31 are provided is not limited to the protruding direction of the tab 30. For example, the plurality of protrusions 31 may be formed to extend from the end surface TE1 of the tab 30 toward the frame portion 20. In this case, the plurality of protrusions 31 may be arranged in a direction intersecting the protruding direction of the tab 30. That is, the arrangement direction of the plurality of protrusions 31 may be a direction intersecting the protruding direction of the tab 30.

### Filter Device

The filter device is a device including the above-described filter 1, and is, for example, a filtration device. The filter device can be formed of, for example, a material such as a synthetic resin having transparency. In a case where the filter device is formed of a material having transparency, the held filter 1 can be visually confirmed from the outside of the filter device.

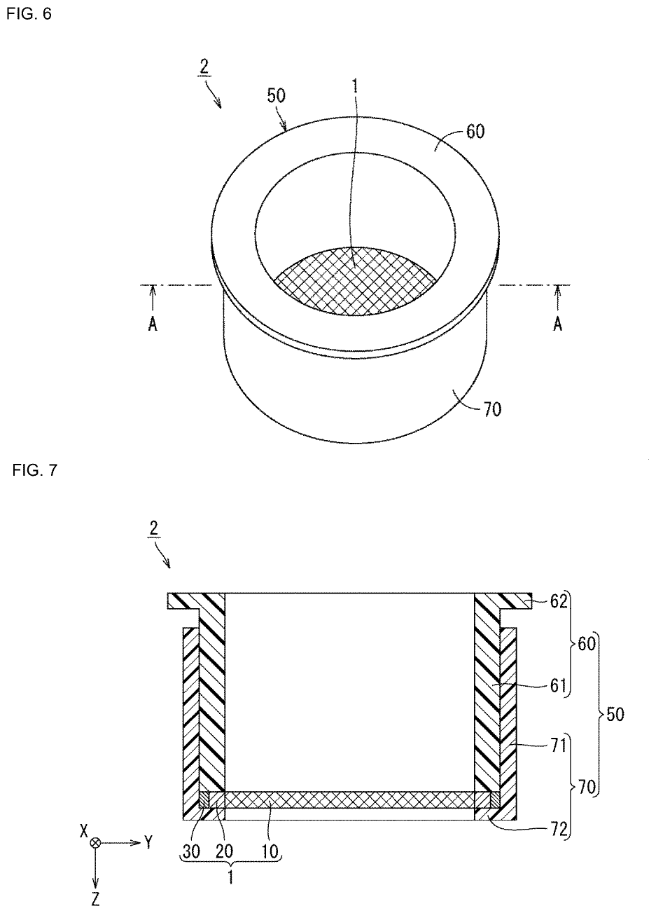

FIG. 6 is a schematic perspective view of an example of a filter device 2 of Embodiment 1 according to the present disclosure. FIG. 7 is a schematic sectional view taken along line A-A of the filter device 2 of FIG. 6. FIG. 8 is an enlarged sectional view of a part of the filter device 2.

As shown in FIGS. 6 to 8, the filter device 2 includes the filter 1 and a holder 50 that holds the filter 1. The holder 50 includes a first holder 60 and a second holder 70. The filter 1 is held by being sandwiched between the first holder 60 and the second holder 70.

### First Holder

The first holder 60 is composed of a member having a cylindrical shape. Specifically, the first holder 60 includes a first cylindrical body 61 and a first flange 62 that protrudes from the outer wall of the first cylindrical body 61.

A space through which a fluid can pass is provided inside the first cylindrical body 61. For example, the first cylindrical body 61 has a cylindrical shape.

The first flange 62 is formed of a ring-shaped plate member. The first flange 62 is provided at an end portion of the first cylindrical body 61. The first flange 62 may be referred to as an outer flange 62. The first flange 62 allows easy detection of unevenness in application of force in a case where the holder 50 is assembled. As a result, it is possible to control unevenness of the liquid flow when the liquid containing cells is passed through the filter device 2. In a case where the first holder 60 and the second holder 70 are assembled together, and the force during assembly is unevenly distributed, a gap between the first flange 62 and a second cylindrical body 71 of the second holder 70, which will be described later, is uneven. When cells are passed through the filter device 2 with an uneven gap, the amount of liquid flowing through a portion where the force applied is small (a portion where the gap is large) increases.

### Second Holder

The second holder 70 is composed of a member having a cylindrical shape. Specifically, the second holder 70 includes the second cylindrical body 71 and a second flange 72 that protrudes from the inner wall of the second cylindrical body 71.

A space in which the first cylindrical body 61 can be disposed is provided inside the second cylindrical body 71. For example, the second cylindrical body 71 has a cylindrical shape. The inner diameter of the second cylindrical body 71 is larger than the outer diameter of the first cylindrical body 61. The first cylindrical body 61 moves inside the second cylindrical body 71 while being in contact with the inner wall of the second cylindrical body 71, and can be disposed inside the second cylindrical body 71.

The second flange 72 is formed of a ring-shaped plate member. The second flange 72 is provided at an end portion of the second cylindrical body 71. The second flange 72 may be referred to as an inner flange 72.

In the filter device 2, the filter 1 is disposed on the second flange 72 of the second holder 70. Specifically, the frame portion 20 and the tab 30 of the filter 1 are disposed on the second flange 72. The first holder 60 is disposed in the second holder 70 in a state where the frame portion 20 and the tab 30 of the filter 1 are disposed on the second flange 72. The tab 30 is sandwiched between the first holder 60 and the second holder 70.

As shown in FIG. 8, the tab 30 of the filter 1 is disposed between an end surface HS1 of the first holder 60 and a flange surface HS2 of the second flange 72 of the second holder 70. In the tab 30, the plurality of protrusions 31 are in contact with the end surface HS1 of the first holder 60, the flange surface HS2 of the second flange 72, and an inner wall HS3 of the second holder 70.

As described above, in the filter device 2, the position where the tab 30 is in contact with the end surface HS1 of the first holder 60 and the flange surface HS2 of the second flange 72 is limited to the plurality of protrusions 31. Accordingly, the plurality of protrusions 31 are reliably in contact with and supported by the end surface HS1 of the first holder 60 and the flange surface HS2 of the second flange 72. As a result, the tab 30 can be firmly held by the holder 50.

In addition, in a case where the first holder 60 and the second holder 70 are in contact with the plurality of protrusions 31 to hold the tab 30, it is easier to apply a force to the filter 1 than in a case where the first holder 60 and the second holder 70 hold the tab on which the plurality of protrusions 31 are not provided.

The first main surface PS1 and the second main surface PS2 of the tab 30 are formed of flat surfaces, and the end surface HS1 of the first holder 60 and the flange surface HS2 of the second flange 72 are formed of flat surfaces. In a case where the tab on which the plurality of protrusions 31 are not provided is sandwiched between the first holder 60 and the second holder 70, the flat surfaces are in contact with each other, and the force applied to the tab is thus dispersed. Therefore, the force of sandwiching the tab is dispersed, and it may be difficult to apply a sufficient force for holding the tab.

Although the thickness of the tab 30 is substantially uniform, there may be variations due to manufacturing. Therefore, in a case where the plurality of protrusions 31 are not provided on the tab, and the end surface HS1 of the first holder 60 and the flange surface HS2 of the second flange 72, which are flat surfaces, are brought into contact with the surface of the tab, the surfaces are not sufficiently in contact with each other, and it may be difficult to apply a force uniformly.

In the filter device 2, the position where the tab 30 is in contact with the end surface HS1 of the first holder 60 and the flange surface HS2 of the second flange 72 is limited to the plurality of protrusions 31. Therefore, the plurality of protrusions 31 are reliably in contact with the end surface HS1 of the first holder 60 and the flange surface HS2 of the second flange 72, and a force can be concentrated on the contact portion. Accordingly, the tab 30 is firmly held by the holder 50.

In addition, since the end surface HS1 of the first holder 60 is in contact with the plurality of protrusions 31, a gap SP1 is formed between the first holder 60 and both the tab 30 and the frame portion 20. Specifically, the gap SP1 is formed between the end surface HS1 of the first holder 60 and the first main surface PS1 of the tab 30 and the frame portion 20.

The size of the gap SP1 is substantially equal to the height of the plurality of protrusions 31. Here, the height of the plurality of protrusions 31 is smaller than the size of the openings of the plurality of through-holes 11 of the filter part 10. Therefore, the gap SP1 has a size that does not allow the filtration target captured by the plurality of through-holes 11 to pass through. A fluid, however, can pass through the gap SP1.

For example, in a case where the filter device 2 filters a liquid containing a filtration target, and the filter part 10 is clogged with the filtration target, the liquid can escape from the gap SP1. In addition, by partially providing the tab 30 on the outer periphery of the frame portion 20, the liquid is more likely to escape from the gap SP1 in a portion where the tab 30 is not provided.

In the filter device 2, the plurality of protrusions 31 provided on the end surface TE1 of the tab 30 and the inner wall HS3 of the second holder 70 are in contact with each other. Accordingly, the end surface TE1 of the tab 30 is reliably supported by the inner wall HS3 of the second holder 70, and the misalignment of the filter 1 can be suppressed. Accordingly, the variation in the gap SP1 can be reduced over the entire outer periphery of the filter 1, as compared with a case where the end surface TE1 of the tab 30 is a flat surface.

### Effects

The filter 1 according to Embodiment 1 can exhibit the following effects.

The filter 1 includes the filter part 10 in which the plurality of through-holes 11 are provided, the frame portion 20 provided on the outer periphery of the filter part 10, and the tab 30 that protrudes from the outer periphery of the frame portion 20 and is provided with the plurality of protrusions 31. With such a configuration, the filter 1 can be easily held. For example, the filter 1 can be easily held by using the holder 50 to sandwich the tab 30.

In addition, in a case where the holder 50 is used to sandwich and hold the tab 30, a position where the holder 50 is in contact can be limited to the plurality of protrusions 31. Accordingly, the holding force applied by the holder 50 can be concentrated on the plurality of protrusions 31, and the force for holding the filter 1 can be improved. As a result, the filter 1 can be firmly held.

In addition, since the plurality of protrusions 31 are in contact with the holder 50, the gap SP1 can be provided between the holder 50 and both the tab 30 and the frame portion 20. Accordingly, for example, in a case where the filter 1 is clogged, the liquid can escape from the gap SP1, and the damage to the filter 1 can be suppressed. In addition, since the plurality of protrusions 31 are in contact with the holder 50, the cells are prevented from going around the end surface TE1 of the tab 30, and the variation in the size of the desired filtration target can be reduced.

The plurality of protrusions 31 are provided on the main surface of the tab 30. The main surface of the tab 30 includes the first main surface PS1 and the second main surface PS2. With such a configuration, in a case where the holder 50 is used to sandwich and hold the tab 30, the holder 50 is reliably brought into contact with the plurality of protrusions 31, the filter 1 can be easily held, and the force for holding the filter 1 can be improved. The heights H1 of the plurality of protrusions 31 do not have to be constant. That is, the heights H1 of the plurality of protrusions may be different from each other. For example, the height H1 can be changed for each tab to control the flow of the liquid in a case of clogging.

The plurality of protrusions 31 are provided on the end surface TE1 of the tab 30. With such a configuration, when the filter 1 is disposed in the holder 50, the plurality of protrusions 31 come into contact with the inner wall of the holder 50, and the position of the filter 1 can be fixed. As a result, the misalignment of the filter 1 can be suppressed, and the variation in the gap SP1 can be suppressed over the entire outer periphery of the frame portion 20.

The plurality of protrusions 31 are arranged in a predetermined direction. With such a configuration, since the plurality of protrusions 31 and the holder 50 are stably in contact with each other, the filter 1 can be more easily held, and the force for holding the filter 1 can be further improved, so that the filter 1 can be firmly held.

The plurality of protrusions 31 are provided within the predetermined distance L2 from the end surface TE1 of the tab 30, and the predetermined distance L2 is 1/20 to ¾ of the length L1 of the tab 30 in the protruding direction. With such a configuration, the filter 1 can be more easily and firmly held.

The height H1 of the plurality of protrusions 31 is smaller than the size of the openings of the plurality of through-holes 11. With such a configuration, the size of the gap SP1 formed between the holder 50 and both the tab 30 and the frame portion 20 is smaller than the size of the filtration target captured by the filter part 10. Accordingly, in a case where clogging or the like occurs, it is possible to allow the liquid to escape from the gap SP1 while suppressing passing of the filtration target through the gap SP1. As a result, the damage to the filter 1 can be further suppressed.

The tab 30 includes a plurality of tabs 30, and the plurality of tabs 30 are provided at equal intervals on the outer periphery of the frame portion 20. With such a configuration, the filter 1 can be more easily and firmly held.

The filter 1 contains at least one of a metal and a metal oxide as a main component. With such a configuration, the filter 1 can be more easily and firmly held.

The filter device 2 includes the filter 1 described above and the holder 50 that holds the filter 1. The holder 50 includes the first holder 60 having a cylindrical shape and the second holder 70 having a cylindrical shape and having the inner flange 72 that protrudes from the inner wall. The first holder 60 is disposed in the second holder 70. The tab 30 of the filter 1 is disposed between the end surface HS1 of the first holder 60 and the inner flange 72 of the second holder 70. The plurality of protrusions 31 of the tab 30 are in contact with at least one of the end surface HS1 of the first holder 60 and the inner flange 72 of the second holder 70. With such a configuration, the filter 1 can be easily held.

In addition, the plurality of protrusions 31 are reliably in contact with and supported by the end surface HS1 of the first holder 60 and the flange surface HS2 of the second flange 72. As a result, the tab 30 can be firmly held by the holder 50.

The plurality of protrusions 31 are provided on the end surface TE1 of the tab 30 and are in contact with the inner wall HS3 of the second holder 70. With such a configuration, the misalignment of the filter 1 can be suppressed. Accordingly, the variation in size of the gap SP1 can be reduced over the entire outer periphery of the filter 1.

In Embodiment 1, an example in which the plurality of protrusions 31 are provided on the first main surface PS1, the second main surface PS2, and the end surface TE1 of the tab 30 has been described, but the present disclosure is not limited thereto. The plurality of protrusions 31 may be provided on at least one of the first main surface PS1, the second main surface PS2, and the end surface TE1 of the tab 30. For example, the plurality of protrusions 31 are provided on the first main surface PS1 of the tab 30, but are not necessarily provided on the second main surface PS2 and the end surface TE1 of the tab 30. In a case where the plurality of protrusions 31 are provided on any one of the first main surface PS1 or the second main surface PS2, it is easy to discriminate the front and back of the filter 1.

In Embodiment 1, the example in which the tabs 30 are provided at equal intervals on the outer periphery of the frame portion 20 has been described, but the present disclosure is not limited thereto. For example, the tabs 30 may be randomly provided on the outer periphery of the frame portion 20. In addition, the disposition and the number of tabs 30 may be changed for each dimension of the through-hole and/or each material of the filter 1. Accordingly, the specifications of the filter can be identified by visual inspection. Further, by creating a portion where the number of tabs 30 is large and a portion where the number of tabs 30 is small, the deformation amount of the filter 1 is small in the portion where the number of tabs 30 is large, and the deformation amount of the filter 1 is large in the portion where the number of tabs 30 is small. As a result, deformation at the filter center portion is dispersed, the entire filter can be uniformly used, and the flow time can be shortened.

In Embodiment 1, an example in which the filter 1 is a metal filter has been described, but the present disclosure is not limited to this. For example, the filter 1 may be a resin-made filter.

Hereinafter, modification examples will be described.

### Modification Example 1

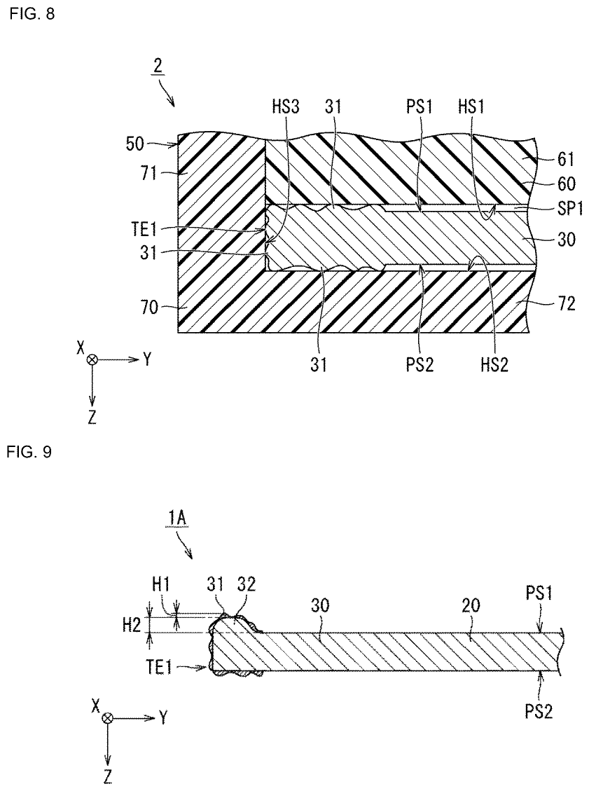

FIG. 9 is a schematic enlarged sectional view of a part of a filter 1A of Modification Example 1. As shown in FIG. 9, in the filter 1A of Modification Example 1, the tab 30 has a first raised portion 32 that is raised in the thickness direction of the tab 30. A height H2 of the first raised portion 32 is larger than the height H1 of the plurality of protrusions 31, and the plurality of protrusions 31 are provided on the first raised portion 32. Other configurations of Modification Example 1 are the same as those of Embodiment 1.

The first raised portion 32 is provided on the first main surface PS1 of the tab 30 along the end surface TE1 of the tab 30. The first raised portion 32 has a projecting shape. For example, the first raised portion 32 has a substantially semicircular shape.

Also in such a configuration, the filter 1 can be easily held. In addition, the filter 1 can be firmly held by the first raised portion 32 while ensuring the gap SP1.

### Modification Example 2

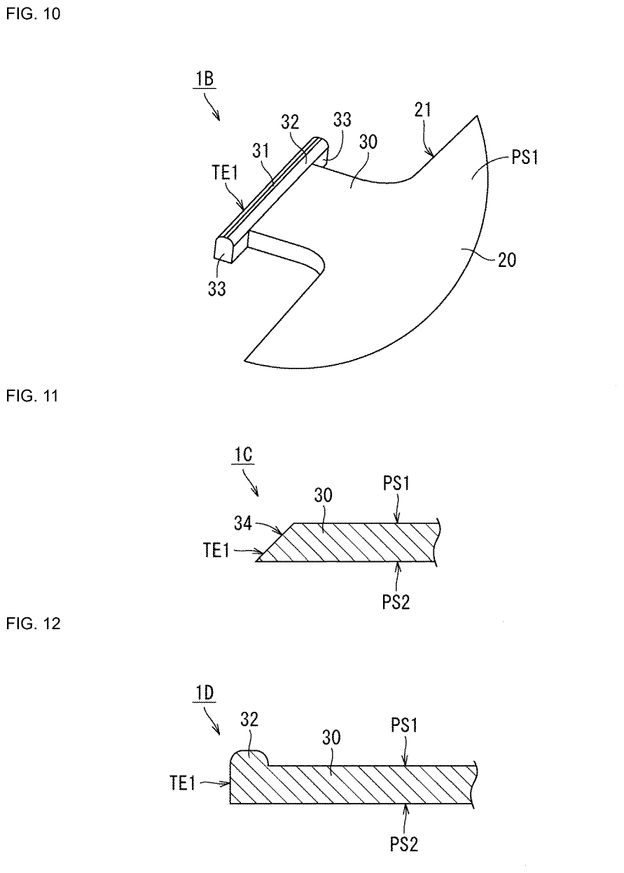

FIG. 10 is a schematic enlarged view of a part of a filter 1B of Modification Example 2. As shown in FIG. 10, in the filter 1B of Modification Example 2, the tab 30 has a second raised portion 33 that is raised in the width direction of the tab 30 at an end portion of the tab 30. The plurality of protrusions 31 are provided on the second raised portion 33. Other configurations of Modification Example 2 are the same as those of Modification Example 1.

The second raised portion 33 is raised in a direction along the end surface TE1 of the tab 30 and protrudes from the side surface of the tab 30. The second raised portion 33 may have the same shape as the first raised portion 32 or may be lower than the first raised portion 32 as viewed from the side surface of the tab 30. By making the height of the second raised portion 33 lower than the height of the first raised portion 32, in a case where clogging or the like occurs, a larger amount of liquid can escape from the gap SP1. As a result, the damage to the filter 1B can be further suppressed.

Also in such a configuration, the filter 1 can be easily held. In addition, since the plurality of protrusions 31 can be provided to be longer in the width direction of the tab 30 by the second raised portion 33, the force for holding the filter 1 can be improved, and the filter 1 can be firmly held.

### Modification Example 3

FIG. 11 is a schematic enlarged sectional view of a part of a filter 1C of Modification Example 3. As shown in FIG. 11, in the filter 1C of Modification Example 3, the end surface TE1 of the tab 30 may form an inclined surface 34. The plurality of protrusions 31 are not provided on the tab 30 of the filter 1C. Other configurations of Modification Example 3 are the same as those of Embodiment 1.

With such a configuration, the tip of the tab 30 is easily deformed, and the tab 30 can be easily disposed in the holder 50. In the tab 30, the area of the first main surface PS1 is smaller than the area of the second main surface PS2, and the area of the first main surface PS1 that is in contact with the holder 50 is smaller than the area of the second main surface PS2. Therefore, in the filter 1C, the deformation amount of the filter when the fluid flows is larger than that of the filter not having the inclined surface 34. As a result, the fluid is dispersed on the filter 1C, and the load on the filter 1C can be reduced.

In Modification Example 3, the plurality of protrusions 31 may be provided on the tab 30.

### Modification Example 4

FIG. 12 is a schematic enlarged sectional view of a part of a filter 1D of Modification Example 4. As shown in FIG. 12, the filter 1D of Modification Example 4 is different from the filter 1A of Modification Example 1 in that the plurality of protrusions 31 are not provided. Other configurations of Modification Example 4 are the same as those of Modification Example 1.

Also in such a configuration, the filter 1 can be easily held.

### Modification Example 5

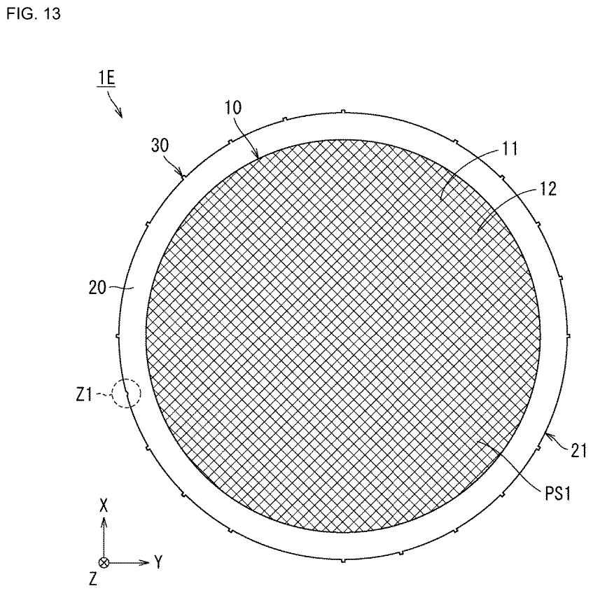

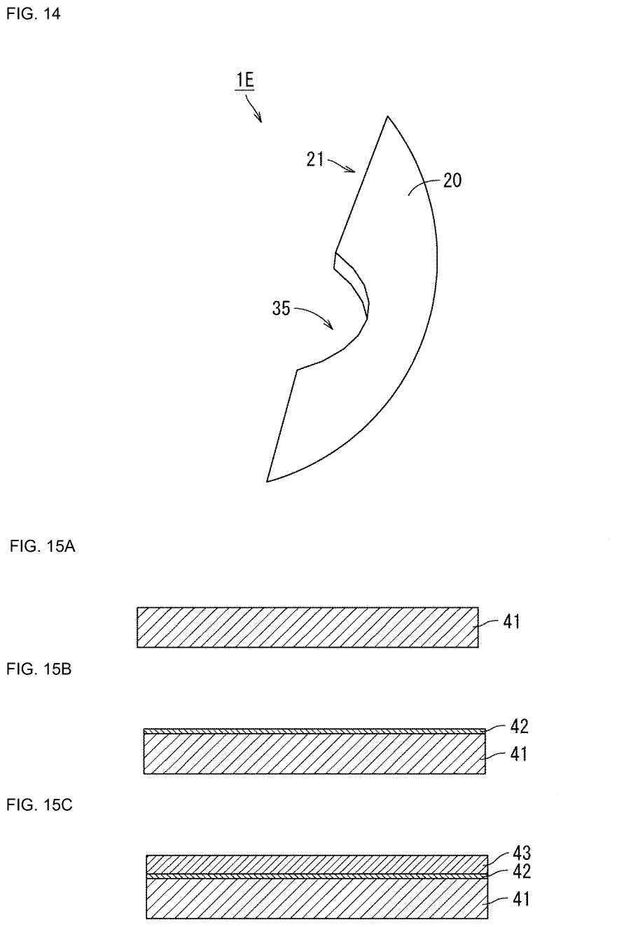

FIG. 13 is a schematic plan view of a filter 1E of Modification Example 5. FIG. 14 is a schematic enlarged view of Z1 portion of the filter 1E of Modification Example 5 of FIG. 13. As shown in FIGS. 13 and 14, in the filter 1E of Modification Example 5, a notch 35 is provided on the outer periphery of the frame portion 20.

Since the notch 35 is provided, for example, the filter 1 can be easily attached to and detached from the holder 50 by inserting a tip of the tweezers into the notch 35 to hold the filter 1E. In the filter 1E, when a fluid is caused to flow, the deformation amount is larger than that of a filter having no notch. Therefore, the fluid can be dispersed on the filter 1E, and the load on the filter 1E can be reduced.

In Modification Example 5, an example in which the notch 35 is provided in the filter 1E has been described, but the present disclosure is not limited thereto. The notch 35 is not necessarily an essential configuration of the filter 1E. For example, in a part of the filter 1E, the interval between two adjacent tabs 30 may be made larger than other intervals to make the portion where the tab 30 is not provided larger. Also in such a configuration, when a fluid is caused to flow, the deformation amount of the filter 1E can be increased, and the load on the filter 1E can be reduced.

### Manufacturing Method of Filter

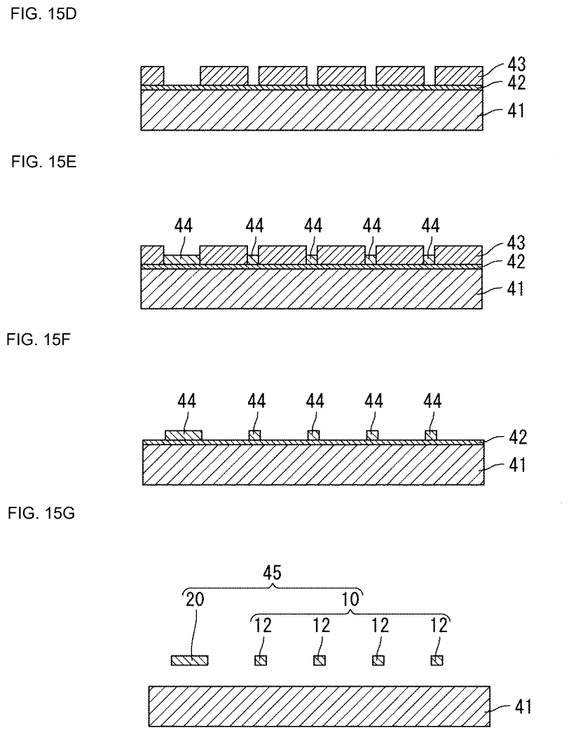

An example of the manufacturing method of the filter 1 will be described with reference to FIGS. 15A to 15G. FIGS. 15A to 15G are schematic views showing an example of a manufacturing process of the filter 1 of Embodiment 1 according to the present disclosure.

As shown in FIG. 15A, a substrate 41 such as a silicon substrate is prepared. The surface of the substrate 41 may be cleaned, for example.

As shown in FIG. 15B, a Cu film 42 is formed on the substrate 41. For example, the Cu film 42 is formed by sputtering using a sputtering deposition apparatus. Alternatively, the Cu film 42 may be formed by vapor deposition using a vapor deposition apparatus. In this case, in order to improve the adhesiveness between the substrate 41 and the Cu film 42, a Ti film may be formed between the substrate 41 and the Cu film 42. For example, the thickness of the Cu film 42 is 500 nm, and the thickness of the Ti film is 50 nm.

As shown in FIG. 15C, a resist is applied onto the Cu film 42 and dried to form a resist film 43. For example, a photosensitive positive liquid resist (Pfi-3A, manufactured by Sumitomo Chemical Co., Ltd.) is applied onto the Cu film 42 by using a spin coater. Next, the resist is heated and dried using a hot plate to form the resist film 43. For example, the thickness of the resist film 43 is 2 μm.

As shown in FIG. 15D, the resist film 43 is exposed and developed, and the resist film 43 at the portions corresponding to the filter substrate part 12 and the frame portion 20 is removed. For example, an i-line stepper (FPA-3030i5+, manufactured by Canon Inc.) is used as an exposure machine.

The development is performed using a puddle development device. As a developer, tetramethylammonium hydroxide (TMAH) is used. After the exposure and the development treatment, a rinsing treatment and a drying treatment are performed.

As shown in FIG. 15E, electrolytic plating is performed using an electrolytic plating device. As a result, a plating film 44 is formed on the portions from which the resist film 43 has been removed. For example, the plating film 44 is a PdNi plating film.

As shown in FIG. 15F, the resist film 43 is peeled off using a resist peeling device capable of performing a high-pressure spray treatment and a peeling liquid. Then, the plating film 44 is washed with isopropyl alcohol (IPA), rinsed, and dried. The peeling liquid is an organic solvent, and is, for example, N-methyl-2-pyrrolidone (NMP).

As shown in FIG. 15G, a peracetic acid solution is prepared as an etchant, and the Cu film 42 is etched and removed by an immersion treatment while stirring the solution with a stirrer. As a result, the filter substrate part 12 and the frame portion 20 are produced by peeling off the plating film 44 from the substrate 41. That is, a filter body 45 in which the filter part 10 and the frame portion 20 are provided is produced.

In order to improve the mechanical strength of the filter 1, a reinforcing layer may be formed on the second main surface PS2 of the filter 1. For example, a resist film having a thickness of 20 μm is formed on the Cu film 42. The resist film is exposed and developed, and the resist film at the portions corresponding to the frame portion 20 and the reinforcing layer is removed. A filter 1 may be produced by subjecting the Cu film 42 to a plating treatment and removing the resist film by using an organic solvent. For example, the thickness of the reinforcing layer is 10 μm, and the through-holes having a square shape with one side of 285 μm are arranged in a square grid arrangement at a pitch of 300 μm.

By performing the processes shown in FIGS. 15A to 15G, a filter sheet including a plurality of filter bodies 45 is formed.

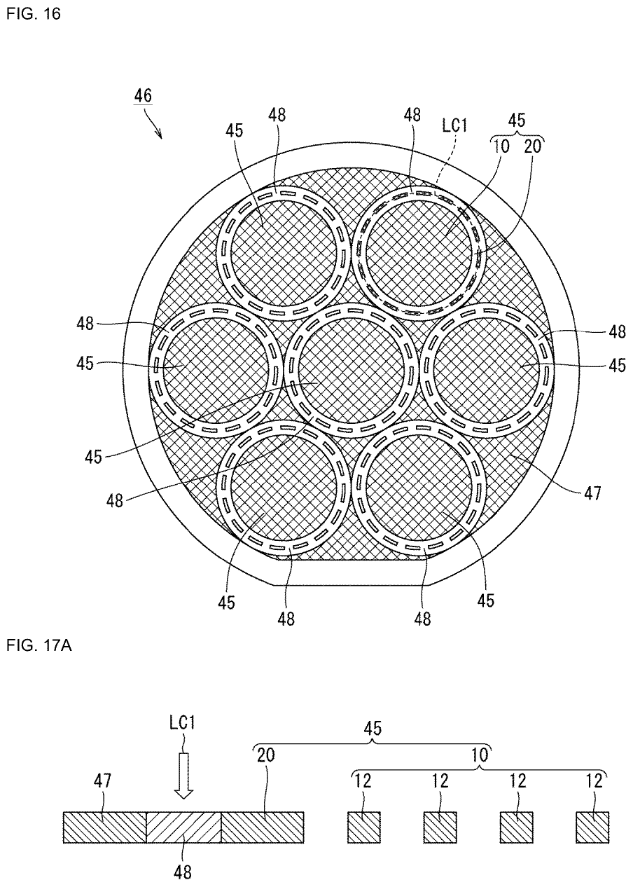

FIG. 16 is a schematic view showing an example of a filter sheet 46. As shown in FIG. 16, the filter sheet 46 has a sheet body 47 in which a plurality of filter bodies 45 are provided. The plurality of filter bodies 45 are connected to the sheet body 47 by a plurality of connection tabs 48.

The plurality of connection tabs 48 are provided at intervals on the outer periphery of the filter body 45. For example, the plurality of connection tabs 48 are provided at equal intervals.

In the manufacturing method of the filter 1, the filter body 45 is separated from the sheet body 47 by cutting the plurality of connection tabs 48 with laser light LC1. Thus, the filter 1 can be obtained. In this case, the plurality of tabs 48 do not have to have a constant width. That is, the widths of the plurality of tabs 48 may be different from each other. Accordingly, both sufficient strength for connection to the sheet body 47 and ease of cutting can be achieved.

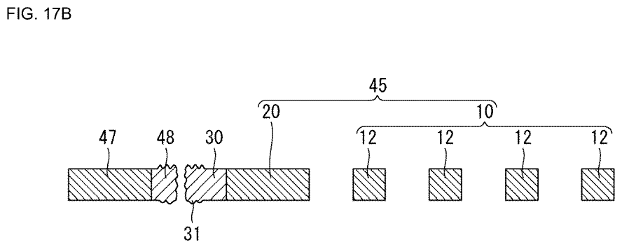

FIGS. 17A and 17B are schematic views showing an example of a manufacturing process of the filter 1 of Embodiment 1 according to the present disclosure. FIGS. 17A and 17B are partial sectional views showing a portion where the connection tab 48 is provided.

As shown in FIG. 17A, the filter body 45 is connected to the sheet body 47 via the connection tab 48. In the manufacturing method of the filter 1, the connection tab 48 is cut by irradiating the connection tab 48 with the laser light LC1.

The laser light LC1 is emitted by, for example, a laser processing device. For example, the laser is a CO₂ laser, a YAG laser, a fiber laser, or a semiconductor laser.

As shown in FIG. 16, the connection tab 48 is irradiated with the laser light LC1 along the outer periphery of the frame portion 20 of the filter body 45. The connection tab 48 is melted and cut by the thermal energy of the laser light LC1.

As shown in FIG. 17B, the connection tab 48 is melted and cut by the laser LC1, whereby the tab 30 on which the plurality of protrusions 31 are provided is formed on the outer periphery of the frame portion 20.

When all the connection tabs 48 provided on the outer periphery of the filter body 45 are cut by the irradiation of the laser LC1, the filter body 45 provided with the plurality of tabs 30 is separated from the sheet body 47. Thus, the filter 1 can be obtained.

In the present specification, the terms “first”, “second”, and the like are used only for description and should not be understood as indicating or implying the relative importance or the rank of technical features. The features limited to “first” and “second” are intended to specify or imply that one or more of the features are included.

The present disclosure is described in detail in connection with preferred embodiments with reference to the accompanying drawings, but various modifications and corrections are apparent to those skilled in the art of the technology. Such modification or correction should be understood to be included in the scope of the present disclosure as long as it is within the scope of the present disclosure defined by the appended claims.

### Outline of Embodiment

(1) A filter according to an aspect of the present disclosure includes: a filter part having a plurality of through-holes; a frame portion on an outer periphery of the filter part; and a tab that protrudes from an outer periphery of the frame portion, the tab having a plurality of protrusions.

(2) In the filter of (1), the plurality of protrusions may be on a main surface of the tab.

(3) In the filter of (1) or (2), the plurality of protrusions may be on an end surface of the tab.

(4) In the filter of any one of (1) to (3), the plurality of protrusions may be arranged in a predetermined direction.

(5) In the filter of any one of (1) to (4), the plurality of protrusions may be provided within a predetermined distance from an end surface of the tab. The predetermined distance may be 1/20 to ¾ of a length of the tab in a protruding direction of the tab from the outer periphery of the frame portion.

(6) In the filter of any one of (1) to (5), a height of the plurality of protrusions may be smaller than a maximum width of openings of the plurality of through-holes.

(7) In the filter of any one of (1) to (6), the tab may have a first raised portion that is raised in a thickness direction of the tab. A height of the first raised portion may be greater than a height of the plurality of protrusions. The plurality of protrusions may be provided on the first raised portion.

(8) In the filter of any one of (1) to (7), the tab may have a second raised portion that is raised in a width direction of the tab at an end portion of the tab. The plurality of protrusions may also be on the second raised portion.

(9) In the filter of any one of (1) to (8), the tab may include a plurality of tabs. The plurality of tabs may be spaced at equal intervals on the outer periphery of the frame portion.

(10) In the filter of any one of (1) to (9), the filter may contain at least any one of a metal and a metal oxide as a main component.

(11) A filter device according to an aspect of the present disclosure includes: a filter; and a holder that holds the filter. The filter includes a filter part having a plurality of through-holes, a frame portion on an outer periphery of the filter part, and a tab that protrudes from an outer periphery of the frame portion, the tab having a plurality of protrusions. The holder includes a first holder that has a cylindrical shape, and a second holder that has a cylindrical shape and has an inner flange protruding from an inner wall thereof. The first holder is disposed in the second holder. The tab of the filter is disposed between an end surface of the first holder and the inner flange of the second holder. The plurality of protrusions of the tab are in contact with at least one of the end surface of the first holder and the inner flange of the second holder.

(12) In the filter device of (11), the plurality of protrusions may be on an end surface of the tab and in contact with the inner wall of the second holder.

The filter of the present disclosure is useful for use in filtering out a filtration target in a fluid.

### REFERENCE SIGNS LIST

1, 1A, 1B, 1C, 1D, 1E Filter
2 Filter device
10 Filter part
11 Through-hole
12 Filter substrate part
20 Frame portion
30 Tab
31 Protrusion
32 First raised portion
33 Second raised portion
34 Inclined surface
35 Notch
41 Substrate
42 Cu film
43 Resist film
44 Plating film
45 Filter body
46 Filter sheet
47 Sheet body
48 Connection tab
50 Holder
60 First holder
61 First cylindrical body
62 First flange
70 Second holder
71 Second cylindrical body
72 Second flange

1. A filter comprising:
a filter part having a plurality of through-holes;
a frame portion on an outer periphery of the filter part; and
a tab that protrudes from an outer periphery of the frame portion, the tab having a plurality of protrusions.

2. The filter according to claim 1, wherein the plurality of protrusions are on a main surface of the tab.

3. The filter according to claim 1, wherein the plurality of protrusions are on an end surface of the tab.

4. The filter according to claim 1, wherein the plurality of protrusions are on a main surface of the tab and on an end surface of the tab.

5. The filter according to claim 1, wherein the plurality of protrusions are arranged in a predetermined direction.

6. The filter according to claim 1, wherein the plurality of protrusions are within a predetermined distance from an end surface of the tab, and
the predetermined distance is 1/20 to ¾ of a length of the tab in a protruding direction of the tab from the outer periphery of the frame portion.

7. The filter according to claim 1, wherein a height of the plurality of protrusions is smaller than a maximum width of openings of the plurality of through-holes.

8. The filter according to claim 1, wherein the tab has a first raised portion that is raised in a thickness direction of the tab,
a height of the first raised portion is greater than a height of the plurality of protrusions, and
the plurality of protrusions are on the first raised portion.

9. The filter according to claim 8, wherein the tab has a second raised portion that is raised in a width direction of the tab at an end portion of the tab, and
the plurality of protrusions are also on the second raised portion.

10. The filter according to claim 1, wherein the tab has a raised portion that is raised in a width direction of the tab at an end portion of the tab, and
the plurality of protrusions are on the second raised portion.

11. The filter according to claim 1, wherein the tab includes a plurality of tabs, and
the plurality of tabs are spaced at equal intervals on the outer periphery of the frame portion.

12. The filter according to claim 1, wherein the filter contains at least any one of a metal and a metal oxide as a main component.

13. A filter device comprising:
a filter; and
a holder that holds the filter, wherein
the filter includes:
a filter part having a plurality of through-holes,
a frame portion on an outer periphery of the filter part, and
a tab that protrudes from an outer periphery of the frame portion, the tab having a plurality of protrusions,
the holder includes:
a first holder that has a cylindrical shape, and
a second holder that has a cylindrical shape and has an inner flange protruding from an inner wall thereof,
the first holder is disposed in the second holder,
the tab of the filter is disposed between an end surface of the first holder and the inner flange of the second holder, and
the plurality of protrusions of the tab are in contact with at least one of the end surface of the first holder and the inner flange of the second holder.

14. The filter device according to claim 11, wherein the plurality of protrusions are on an end surface of the tab and are in contact with the inner wall of the second holder.

15. The filter device according to claim 13, wherein the plurality of protrusions are on a main surface of the tab.

16. The filter device according to claim 13, wherein the plurality of protrusions are on an end surface of the tab.

17. The filter device according to claim 13, wherein the plurality of protrusions are on a main surface of the tab and on an end surface of the tab.

18. The filter device according to claim 13, wherein the plurality of protrusions are arranged in a predetermined direction.

19. The filter device according to claim 13, wherein the plurality of protrusions are within a predetermined distance from an end surface of the tab, and
the predetermined distance is 1/20 to ¾ of a length of the tab in a protruding direction of the tab from the outer periphery of the frame portion.

20. The filter device according to claim 13, wherein a height of the plurality of protrusions is smaller than a maximum width of openings of the plurality of through-holes.
